(19) United States
(12) Patent Application Publication
(10) Pub. No.: US 2008/0032564 A1
(43) Pub. Date: Feb. 7, 2008

(54) Sealed Lamp Socket

(76) Inventor: William J. Doman, Royal Oak, MI (US)

Correspondence Address: Dickinson Wright PLLC, 38525 Woodward Avenue, Suite 2000, Bloomfield Hills, MI, 48304, US

(21) Appl. No.: 11/617,829

(22) Filed: Dec. 29, 2006

Related U.S. Application Data
(60) Provisional application No. 60/821,003, filed on Aug. 1, 2006.

(51) Int. Cl. H01R 24/00

(52) U.S. Cl. 439/699.2

(57) ABSTRACT

Wedge bulb lamp sockets with one or more terminal members potted in the lamp socket bodies. The terminals have wire lead supporting members positioned at 100-150° from the axial axis of the body. The blades of the terminals have locking tabs to assist in securing the terminals in place.

### CROSS-REFERENCE TO RELATED APPLICATIONS

This application is related to Provisional Patent Application Ser. No. 60/821,003 filed on Aug. 1, 2006.

### TECHNICAL FIELD

The present invention relates generally to wedge bulb lamp sockets and more particularly to lamp sockets having terminals that facilitate potting.

### BACKGROUND OF THE INVENTION

Structural requirements for lamp sockets vary widely depending on the application in which the lamp and the socket are to be used. Some of the most demanding applications are those in which the lamp and socket may be exposed to variable and occasionally harsh environmental conditions. Such conditions can expose portions of the lamp and/or socket vulnerable to those environmental conditions, potentially affecting functioning of the lamp and socket. For instance, exposure to water in the form of rain or high humidity can cause corrosion and shorting, leading to failure of the lamp.

One way to minimize the risk of failure is to present exposure of vulnerable portions of a lamp and/or socket assembly to the effects of harsh environments. In particular, the connection of a lamp to a power supply must be maintained in order to prevent failure of lamp function. Typically, such a connection is protected by embedding the connection in a material which seals the connection against water or other detrimental conditions. For example, a sealing material may be used to protect these sensitive components from impact, shock, vibration, moisture and chemicals.

In spite of the effectiveness of sealing approaches, they are limited by certain socket design constraints. In many applications for a lamp socket, space considerations are paramount. Thus, while in some socket assemblies the orientation of the portion of the socket which receives the lamp is axial with respect to the portion of the socket which supports the terminal lead, a space saving configuration has evolved in which these components are disposed perpendicularly with respect to each other. However, while saving space, the perpendicular orientation creates a configuration in which the terminal lead lies in close proximity to a wall of the socket. When a potting material is applied to encapsulate and preserve the connection between the terminal lead and the terminal, the clearance between the connection and the wall is in some instances not sufficient to allow reproducible flow-through of the potting material, resulting in a situation in which a portion of the terminal or lead may be exposed. His can lead to failure of lamp function in an undesirable number of cases.

Thus, there is a continuing need for a lamp terminal and for a lamp socket assembly which allows for improved efficiency of potting connection between a wire lead and the lamp terminal and thereby provide for superior performance under harsh environmental conditions.

### SUMMARY OF THE INVENTION

A potted terminal and lamp socket assembly are provided according to the present invention that assure complete potting of the terminal connection to a wire. A lamp terminal according to the present invention is described herein which includes a lamp receptacle and a lead support for supporting an electrical lead. The lamp receptacle terminal blade and the wire lead support portions of the lamp terminal are disposed such that the lamp receptacle terminal blade and the wire lead support define an angle in the range of 100 to 150 degrees. In further embodiment, the lamp receptacle terminal blade and the wire lead support from an angle in the range of about 105-130. In still further embodiments, the lamp receptacle terminal blade and the wire lead support form an angle in the range of about 115-125 degrees, and preferably 120 degrees.

A lamp socket assembly is provided according to the present invention which includes a lamp socket body having a support wall for supporting a lamp terminal. A lamp terminal positioned in contact with the support wall has a lamp receptacle terminal blade and a wire lead support. As described above, the lamp receptacle terminal blade and the wire lead support are disposed such that the lamp receptacle and the lead support form an angle of from 100-150 degrees. In such an embodiment, the lead support and the wall form an angle to the range of 10 to 60 degrees. This defines a potting material space between the lead support and the wall which allows potting material to be easily and reproducibly inserted and encapsulate the contact area and seal the lead and support.

Other objects and features of the present invention will become apparent when viewed in light of the detailed description and preferred embodiments when taken in conjunction with the attached drawings and appended claims.

### BRIEF DESCRIPTION OF THE DRAWINGS

FIG. 1 is a cross-sectional view of an inventive lamp socket assembly along line A-A of FIG. 4.

FIG. 2 is a cross-sectional view of an inventive lamp socket assembly along line C-C of FIG. 4.

FIG. 3 is a cross-sectional view of an inventive lamp socket assembly along line B-B of FIG. 4.

FIG. 4 is an external top perspective view of an inventive lamp socket assembly.

FIG. 5 illustrates the various axes and angles of the inventive socket assembly.

FIG. 6 is a perspective view of an electrical terminal lead according to the present invention.

FIG. 7 is a top view of an inventive socket assembly devoid of terminals and spring member.

### DESCRIPTION OF THE PREFERRED EMBODIMENTS

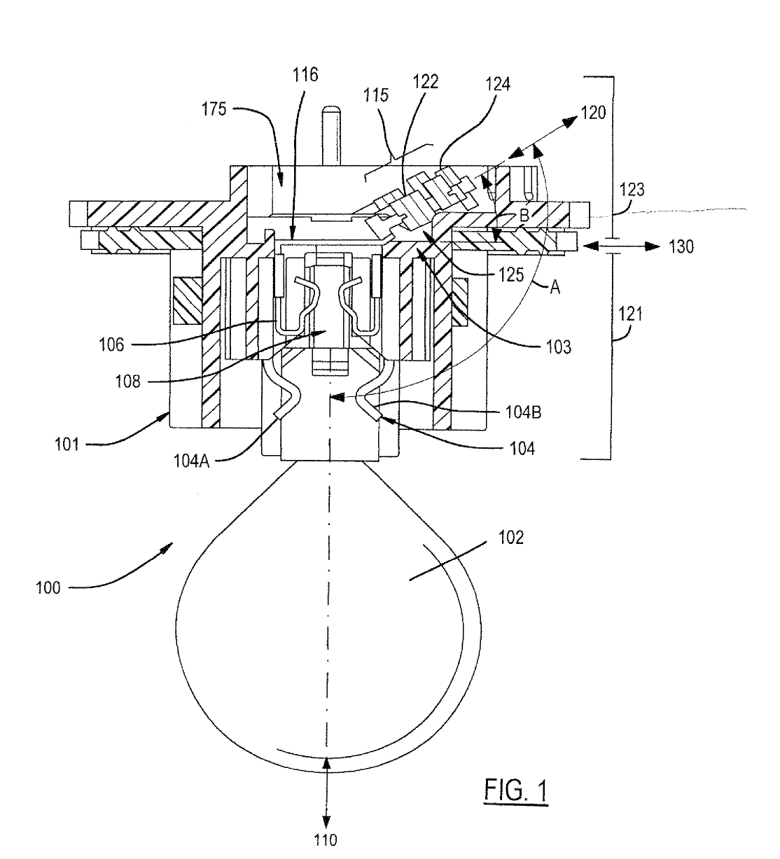

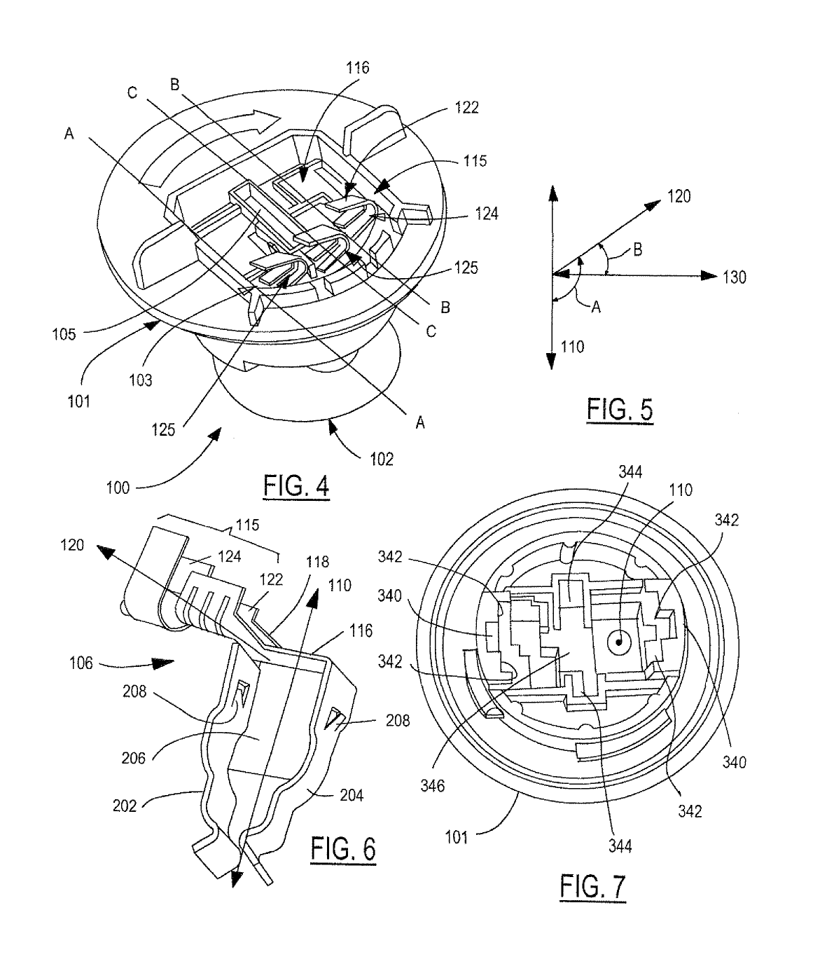

FIG. 1 illustrates an embodiment of an inventive lamp socket assembly 100. A socket body 101 is illustrated in contact with a lamp wedge-type (or light bulb) 102. The lamp is supported and held in place by a metal spring member 104 having opposing arms 104A and 104B. The spring member 104 has a “U”-shaped base 105 (see FIG. 4) that separates the laterally aligned arms. The spring member 104 shown engages a shaped portion of an electrical foot contact 108 of the lamp 102. An electrical contact member 106 of the socket assembly and an electrical foot contact member 108 of the lamp are shown. The tamp receptacle is configured to receive a lamp inserted along the axis indicated at 110.

As shown in FIG. 7, lamp bulb socket body 101 has exterior alignment features 340 that include side rail alignment channels 342 and apertures 344 for the arms of the spring member 104 to extend therethrough, and an axial channel 346. Potted lamp sockets with features of this type are disclosed in U.S. Pat. No. 7,052,301.

As best seen in FIG. 6, a box type electrical terminal 106 has two opposing blades 202 and 204, and an end plate 206. The blades 202 and 204 can vary in shape relative to those depicted in the drawings, and are provided to illustrate that the nature of the contact surface between the blades and the lamp are not critical.

A wire lead support 115 is connected to a cover 116 and includes a lead cradle 122 and a crimp cradle 124. A rear portion 123 of the socket body is separated from potting material flow to a forward portion 121 of the socket body by the cover 116 in combination with one or more walls or the socket body as illustrated at 103. In general, separation between the rear portion 123 and the forward portion 121 is achieved using components, such as the cover 116 and wall 103, oriented substantially perpendicularly with respect to the lamp insertion axis 110.

Preferably, the two opposing blades 202 and 204 include flared tabs 208 formed in each blade. When the electrical terminal 106 is inserted into the channels in the socket body, the tabs 208 secure the terminal 106 in place until the socket is potted. The tabs are spring tabs which protrude from the blades and allow the terminals 106 to be inserted into the channels in the socket body in one direction, but protrude into the plastic socket body material and cannot easily be removed or dislodged in the opposite direction.

As an alternate type of a securing mechanism for securely holding the electrical terminals in place in the lamp socket until they are permanently potted together, one or more nubs or small projections can be provided on one or more walls of the channels in the socket body and corresponding holes or openings can be provided in the blades of the terminals. In this manner, when the terminals are inserted in the lamp sockets, the openings in the blades mate with the projections holding the terminals in place.

The wire lead support 115 is positioned along a wire lead support axis 120 at an angle A with respect to the lamp blade insertion axis 110 defined by the lamp receptacle. This is shown in FIGS. 1 and 4. In addition, the lead support 115 is positioned along a lead support axis 120 at an angle B with respect to the cover 116 and wall 103. The cover 116 and wall 103 are positioned along axis 130. This orientation creates a space 125 allowing room for a potting material and reproducible encapsulation of an electrical connection between an electrical lead and a portion of the lead support. In FIG. 1, the space 125 for insertion of potting material is illustrated between the wall 103 and the lead support 115.

In preferred embodiments, the angle A formed between the lamp receptacle positioned along axis 110, and the lead support positioned along axis 120, is in the range from 100 to 150 degrees. In further preferred embodiments, the angle formed between the lamp receptacle positioned along axis 110 and the lead support positioned along axis 120, is in the range of about 105-130 degrees. Still further preferred are embodiments in which the angle formed between the lamp receptacle positioned along axis 110, and the lead support positioned along axis 120, is in the range of about 115-125 degrees.

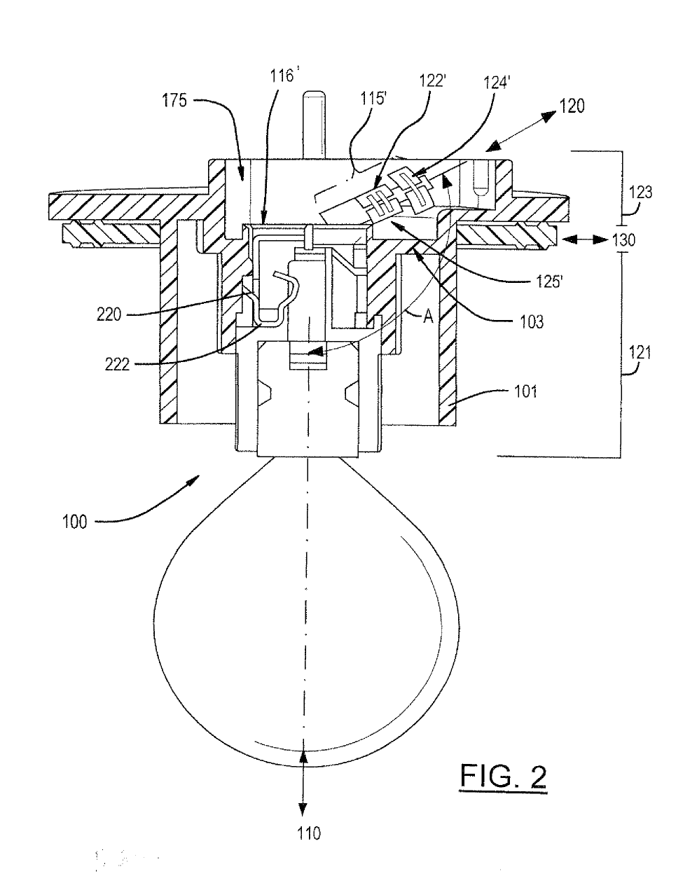

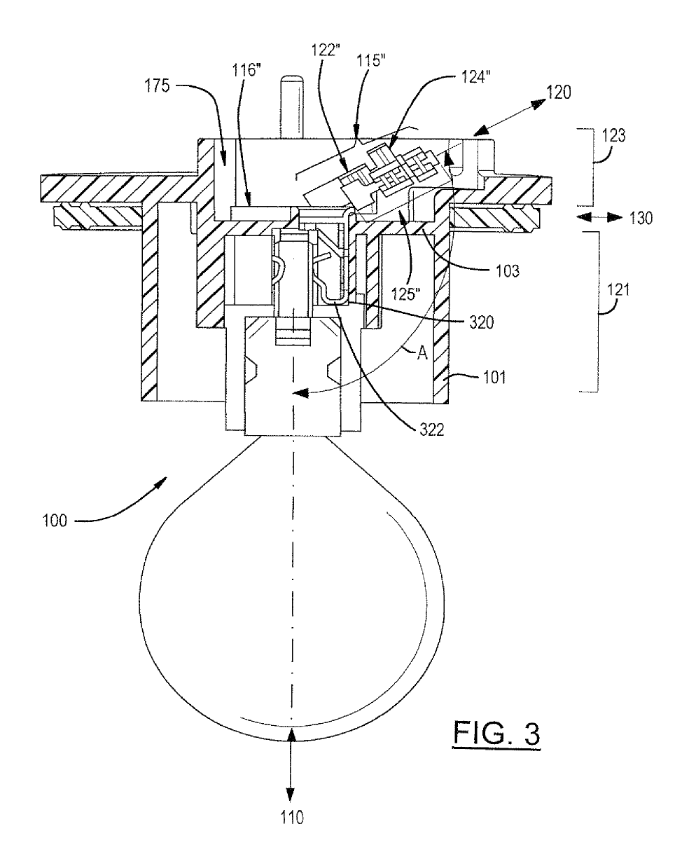

FIGS. 2 and 3 further illustrate cross-sectional views of a lamp socket assembly according to the present invention along lines C-C and B-B, respectively, as shown in FIG. 4. FIG. 4 is an external top perspective view of an inventive socket assembly.

As best shown in FIGS. 2 and 3, single blade terminals 220 and 320 are shown with greater clarity, respectively, where primed (′) and double primed (″) numerals correspond to the features detailed with respect to FIG. 1. The terminals 220 and 320 are similar to terminals 106, but each only have one blade.

Wire lead supports 115′ and 115″ are connected to covers 116′ or 116″ and include lead cables 122′ or 122″ and crimp cradles 124′ and 124″. The terminals 220 and 320 terminate in contact blades 222 and 322, respectively. Similar to the situation relative to terminal 106 in FIG. 1, the rear portions 123 of the socket bodies are separated from potting material flow from forward portions of the socket bodies 121 by the covers 116′ or 116″ in combination with one or more walls or the socket bodies as illustrated at 103. In general, separation between the rear portions 123 and the forward portions 121 is achieved using components such as the covers 116′ or 116″ and walls 103, oriented substantially perpendicularly with respect to the lamp insertion axis 110.

The wire lead supports 115′ and 115″ are positioned along a wire lead support axis 120 at the same angle A with respect to the lamp blade insertion axis 110 defined by the lamp receptacle. This orientation creates spaces 125′ and 125″ allowing room for potting material and reproducible encapsulation of an electrical connection between the electrical lead portion and a portion of the lead support. In preferred embodiments, the angle A formed between the lamp receptacle positioned along axis 110, and the lead support positioned along axis 120, is in the range of from 100 to 150 degrees. In further preferred embodiments, the angle A formed between the lamp receptacle positioned along axis 110, and the lead support positioned along axis 120, is in the range of about 105-130 degrees. Still further preferred are embodiments in which the angle A formed between the lamp receptacle positioned along axis 110, and the lead support positioned along axis 120, is in the range of about 115-125 degrees.

While four blades are preferably provided with two opposing blades laterally aligned and two others as illustrated in FIGS. 2 and 3, it is appreciated that any number of contacts greater than two are operative to illuminate a lamp bulb 102 according to the present invention.

Also, the two single blade terminals 220 and 320 preferably have locking tabs (not shown) on the blades in order to assist in retaining the terminals in the lamp socket body. The locking tabs re preferably cut out and formed on the sides of the blades similar to the locking tabs 208 shown in FIG. 6 with reference to terminal 106.

FIG. 5 illustrates the various axes and angles described above. In this diagram, lamp receptacle axis 110, lead support axis 120 and cover and/or wall axis 130 are depicted forming angles A and B as discussed above. Angle A is the angle between the lamp receptacle axis 110 and the lead support axis 120, while angle B is the angle between the lead support axis 120 and the cover and/or wall axis 130.

In preferred embodiments, the terminals are manufactured as single pieces of stamped metal that includes the blades, cover, and lead support. However, it is appreciated that the terminals may be fabricated as two or more pieces for later attachment.

After the lamp socket body is formed and the three terminals are positioned in their respective channels in the body (said terminals having the wire leads previously clamped on them), the recess 175 in the body is filled with a potting material. The potting material fully encapsulates the lead ends of the electrical wires after the terminals are positioned in the lamp socket bodies. The potting material can be any type of known or conventional potting material in use today.

Any patents or publications mentioned in this specification are incorporated herein by reference to the same extent as if each individual publication is specifically and individually indicated to be incorporated by reference.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A lamp terminal comprising:
a lamp receptacle blade member; and
a lead support member for an electrical lead, wherein the lamp receptacle blade and the lead support member form an angle in the range of about 100-150 degrees.

2. The lamp terminal of claim 1 wherein the angle is in the range of about 105-130 degrees.

3. The lamp terminal of claim 1 wherein the angle is in the range of about 115-125 degrees.

4. A lamp socket assembly comprising:
a lamp socket body having a support wall for supporting a lamp terminal; and
a lamp terminal in contact with the support wall, said lamp terminal having at least one lamp receptacle blade and a lead support, wherein said lamp receptacle blade and the lead support form an angle in the range of about 100-150 degrees.

5. The lamp socket assembly of claim 4, wherein the lead support and the support wall form an angle in the range of about 10-60 degrees, thereby defining a potting material space between the lead support and the support wall.

6. The lamp socket assembly of claim 4 wherein the angle is in the range of about 105-130.

7. The lamp socket assembly of claim 4 wherein the angle is in the range of about 115-125 degrees.

8. A lamp socket assembly of claim 4 wherein the lamp electrical terminal is a box terminal having two opposite blades, at least one of said blades having a tab member for assisting in securing said terminal to said lamp socket body.
